(19) United States
(12) Patent Application Publication
(10) Pub. No.: US 2026/0369114 A1
(43) Pub. Date: Nov. 19, 2026

(54) SMART FRAME FOR DETENTION FACILITIES

(71) Applicant: TECZZ LLC, Fond du Lac, WI (US)

(72) Inventors: Thomas Paul Rogers, Ripon, WI (US); Rodney R Kim, Fond du Lac, WI (US); Gunnar J. Schultz, Ripon, WI (US); Noah A Kulas, Fond du Lac, WI (US); Donald Adamski, Fairwater, WI (US)

(73) Assignee: TECZZ LLC, Fond du Lac, WI (US)

(21) Appl. No.: 19/206,936

(22) Filed: May 13, 2025

(51) Int. Cl. G07C 9/00

(52) U.S. Cl. CPC G07C 9/00944; G07C 9/00309; G07C 9/00571; G07C 9/00896; G07C 2009/00793

(57) ABSTRACT

A smart frame for use in detention and secured facility environments includes a door frame supporting a door lock, a modular assembly with a door controller operable to control the door lock, and a door position sensor communicable with the door controller. A network cable transmits power and data to the modular assembly for operating a plurality of modular systems. The smart frame integrates access control, monitoring, and communication functionalities within the door structure, simplifying installation and enhancing security. A detention center security system includes a control center, a smart frame processor, and a plurality of smart frames communicable via the network cable to facilitate centralized control, monitoring, and operation of access points throughout a multi-layered facility. A method of operating a detention facility enables real-time door control and status monitoring using distributed smart frames managed through a centralized control system over a unified power and data network infrastructure.

### TECHNICAL FIELD

The present disclosure relates generally to access control systems and, more particularly, to smart door frames and associated modular assemblies configured for use in secured facilities.

### BACKGROUND

Detention facilities, such as correctional institutions, require secure and reliable door systems to regulate access, ensure the safety of occupants, and maintain controlled movement within the premises. Traditional detention door systems rely on complex wiring infrastructures, requiring multiple independent conductors for various functionalities, including locking mechanisms, tamper detection, door position monitoring, access control, intercom communication, and status indication.

Existing detention door solutions often necessitate early-stage planning to determine specific wiring requirements, increasing installation complexity and limiting flexibility in modifying functionality at later stages of construction. Additionally, conventional wiring methods require compliance with various National Electrical Code (NEC) classifications, leading to the need for separate raceways, conduits, and electrical distribution systems, further driving up installation costs and labor requirements.

Furthermore, conventional systems lack a centralized power and data management approach, resulting in increased maintenance challenges, difficulty in diagnosing system failures, and reduced adaptability to emerging security and automation technologies.

Others have attempted to improve detention door systems through network-based control architectures, such as the system described in U.S. Pat. No. 9,754,433. That system provides a client-server configuration using Ethernet communication to monitor and control individual cell locks. While this approach introduces network integration and centralized control, it still relies on complex, distributed lock modules with embedded servers and individual sensor interfaces. The system also requires customized hardware and software for each lock, as well as separate Bluetooth capabilities for localized control, which can complicate scalability, increase hardware costs, and introduce additional maintenance burdens.

It can therefore be seen that a need exists for an improved detention door system that simplifies installation, enhances functionality, enables real-time monitoring, and reduces wiring complexity by integrating multiple functionalities into a single, streamlined power and communication interface assembly.

### SUMMARY

In accordance with one aspect of the disclosure, a smart frame is provided that includes a door frame supporting a door lock, a modular assembly with a door controller operable to actuate the door lock, and a door position sensor communicable with the door controller. The smart frame integrates a network cable configured to transmit both power and data to the modular assembly for operation of a plurality of modular systems. This configuration enhances security, simplifies installation, and supports modular scalability in high-security environments.

In accordance with another aspect of the disclosure, a detention center security system is provided comprising a smart frame having a door frame, a door lock, a modular assembly with a door controller, and a door position sensor. A network cable is configured to deliver power and data to the modular assembly for managing a plurality of modular systems. The system is structured to support centralized control and real-time monitoring, enabling secure, scalable access management across a detention facility.

In accordance with another aspect of the disclosure, a method of operating a detention facility is provided. The method includes providing a control center, a smart frame processor, and multiple smart frames each having a door frame, a door lock, a modular assembly with a door controller, and a door position sensor. The method further includes transmitting power and data via a network cable to each modular assembly, receiving and processing signals at the door controller to operate the door lock, and distributing operational control from the control center through the smart frame processor to manage modular systems at the door level. This approach enables efficient, real-time access control within multi-layered secure environments.

These and other aspects and features of the present disclosure will be better understood upon reading the following detailed description when read in conjunction with the accompanying drawings.

### BRIEF DESCRIPTION OF THE DRAWINGS

FIG. 1 is a perspective view of a smart frame, according to an embodiment of the present disclosure.

FIG. 2 is a block diagram of a smart frame system, according to an embodiment of the present disclosure.

FIG. 3 is a block diagram illustrating a detention center security network, according to an embodiment of the present disclosure.

FIG. 4 is an isometric view of a smart box, according to an embodiment of the disclosure.

FIG. 5 is a cross-sectional back view of a smart box, according to an embodiment of the disclosure.

FIG. 6 is a cross-sectional top view of a smart box, according to an embodiment of the disclosure.

FIG. 7 is a view of a first module assembly within the smart box of FIG. 4, according to an embodiment of the disclosure.

FIG. 8 is a view of a second module assembly within the smart box of FIG. 4, according to an embodiment of the disclosure.

FIG. 9 is a view of a third module assembly within the smart box of FIG. 4, according to an embodiment of the disclosure.

FIG. 10 is a schematic overview of a multi-layered detention center security network, according to an embodiment of the disclosure.

FIG. 11 is a flow chart of a method of operating a detention facility, according to an embodiment of the disclosure.

The figures depict one embodiment of the presented invention for purposes of illustration only. One skilled in the art will readily recognize from the following discussion that alternative embodiments of the structures and methods illustrated herein may be employed without departing from the principles described herein.

### DETAILED DESCRIPTION

Referring now to the drawings, and with specific reference to the depicted example, a smart frame 100 is shown, illustrated as a smart door frame configured for installation in secured facilities requiring controlled access. Secure entry points such as detention centers, correctional facilities, government buildings, and industrial security zones benefit from reinforced door structures with integrated electronic access control. While the following detailed description describes an exemplary aspect in connection with controlled-access detention environments, it should be appreciated that the description applies equally to secure entry points in commercial and industrial settings where advanced high security access monitoring and control are required.

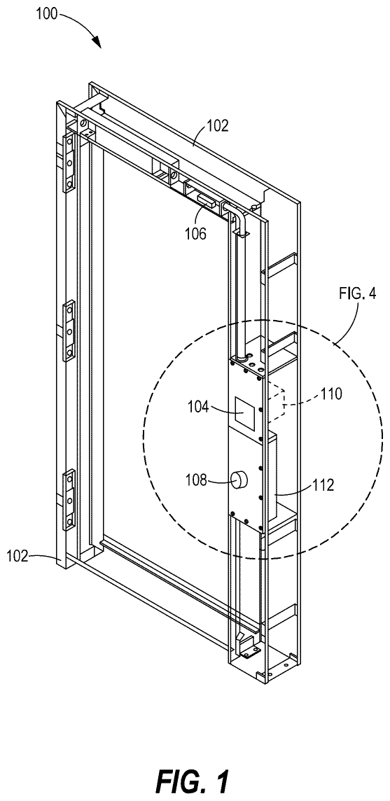

Referring now to FIG. 1, the smart frame 100 is illustrated, according to an embodiment of the disclosure. The smart frame 100 comprises a door frame 102 designed to support and house functional components for electronic access and security monitoring. The smart frame 100 may include an interface 104 for an operator to select commands to operate the smart frame 100. The door position sensor 106 is positioned within the smart frame 100 and is configured to detect whether the door is open or closed. A door lock 108 is secured within the door frame 102 and is operable to engage or release the door based on external access control signals.

The door frame 102 provides structural support and is configured to accommodate various security components within its internal housing. The door position sensor 106 transmits real-time door status data to a controller in the door frame 102 or a remote monitoring system, ensuring active tracking of door movement. The door lock 108 is actuated electronically or electromechanically, allowing for controlled engagement and release, reducing reliance on mechanical locking mechanisms.

The door position sensor 106 is integrated within the structure to provide seamless monitoring of door activity without being externally exposed to tampering. The door lock 108 is constructed for reinforced security, preventing unauthorized entry while enabling automated control through remote commands.

The smart frame 100 further comprises a modular assembly 110 positioned within the door frame 102 and proximate a door lock assembly 112. The door lock assembly 112 controls the door lock 108 and may be an electronic-mechanical door lock assembly in communication with the modular assembly 110, as generally known in the arts. The modular assembly 110 receives and executes commands of operations in the smart frame 100 included opening and closing the door lock 108.

An interface 104 may be provided for on the door frame 102 for an operator to selectively command an operation of the smart frame 100, such as unlocking the door lock 108, executed by the modular assembly 110.

The smart frame 100 is configured to operate as part of a networked access control system, integrating sensors and electronic locks to enhance security and monitoring capabilities. The design minimizes wiring complexity by consolidating power and communication lines into a single structured pathway, ensuring ease of installation and maintenance.

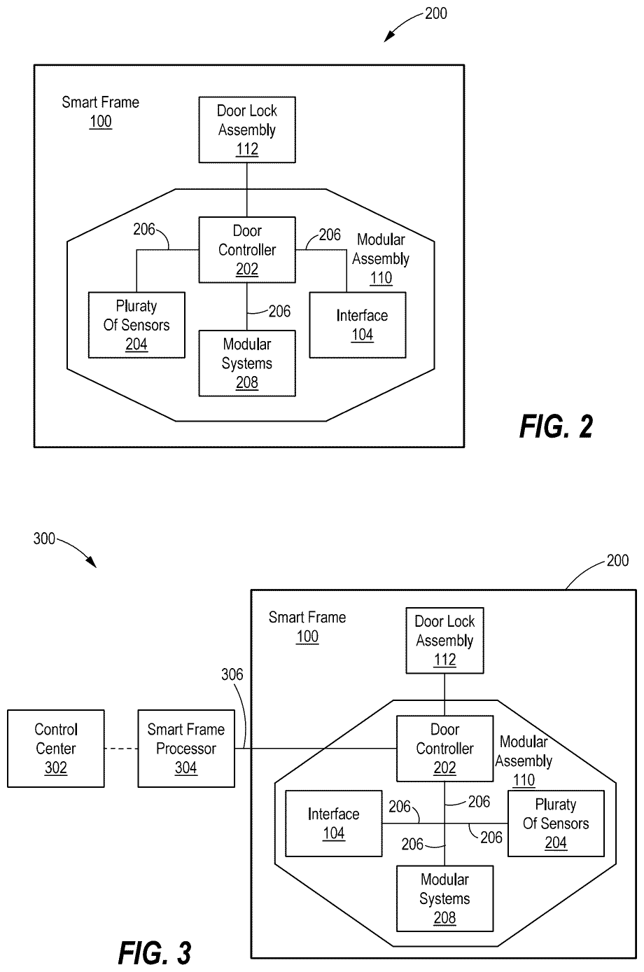

Now referring to FIG. 2, FIG. 2 illustrates a smart frame system 200 of the smart frame 100, according to an embodiment of the disclosure. The smart frame system 200 is configured to manage access control, security monitoring, and real-time data transmission between the modular assembly 110 having a door controller 202 and a plurality of sensors 204 connected via a cable 206. The door position sensor 106 and the door lock assembly 112 may be in communication with the modular assembly 110 via the cable 206. The cable 206 may be a communication wire, as generally known in the electronic arts. The modular assembly 110 may also communicate with the door position sensor 206 and the plurality of sensors 204 via wifi, Bluetooth, or any other electronic communication means, as generally known in the arts.

The door controller 202 is an electronic processing unit configured to receive, process, and transmit data related to the operation of a smart frame 100. The door controller 202 is operably connected to an interface 104, which facilitates communication between the door controller 202 and external access control devices. The interface 104 is structured to support multiple data exchange protocols, enabling integration with security monitoring equipment, access authentication modules, and remote management systems. The smart frame system 200 and the door controller 202 support a plurality of protocols to communicate with industry standard components including but not limited to SIP, VoIP, MQTT, ASCII, Modbus, Fins, Onvif, UDP, TCP/IP, SPI, and others as generally known in the arts.

A plurality of sensors 204 are positioned within the smart frame 100 and are communicable with the door controller 202. The plurality of sensors 204 include at least one of a door position sensor 106, a lock status sensor, and a tamper detection sensor. The door position sensor 106 detects the open or closed state of the door, while the lock status sensor monitors whether the door lock 108 is engaged or disengaged. The tamper detection sensor provides security alerts when unauthorized access attempts or forceful manipulations are detected.

A plurality of modular systems 208 may be controlled by the door controller 202 to regulate access and security functions. The plurality of modular systems 208 includes at least one of an electronic locking mechanism in communication with the door lock assembly 112, an intercom communication module, an access control authentication device, and a visual status indicator. The electronic locking mechanism controls the actuation of the door lock 108, allowing for remote locking and unlocking operations. The intercom communication module enables audio interaction between personnel inside and outside the secure area. The access control authentication device includes biometric scanners, RFID readers, or keypad interfaces for validating authorized users. The visual status indicator provides real-time feedback regarding the operational state of the smart frame 100. The modular assembly 110 may communicate, via the door controller 202, with the plurality of modular systems 208 via the cable 206 or by wifi, Bluetooth, or any other electronic communication means, as generally known in the electronic arts.

A network cable 306 is provided as a communication link configured to transmit both power and data signals between the door controller 202 and external control systems. The network cable 306 is selected from at least one of Category 5e, Category 6, Category 6a, or better cabling standards, ensuring high-speed data transmission and Power over Ethernet functionality. The network cable 306 eliminates the need for separate power wiring, reducing installation complexity and improving reliability.

The network cable 306 ensures uninterrupted power delivery and high-speed data transmission, reducing the need for multiple wiring systems and improving overall efficiency. The plurality of sensors 204 continuously monitor door activity, ensuring enhanced security and operational awareness. The plurality of modular systems 208 provide automated, real-time control over the access and security functions of the smart frame 100.

The smart door system 200 provides a scalable and modular security solution suitable for detention centers, government buildings, and high-security facilities. The integration of the door controller 202, network cable 306, plurality of sensors 204, and plurality of modular systems 208 ensures seamless functionality, remote monitoring, and advanced access control capabilities for the smart frame 100.

Now referring to FIG. 3, FIG. 3 illustrates a detention center security network 300, according to an embodiment of the disclosure. The detention center security network 300 includes a control center 302, a smart frame processor 304, multiple door controllers 202, and the smart frame 100 in communication with the smart frame processor 304. The smart door system 200 is configured to operate within a networked security infrastructure, allowing the smart frame 100 to communicate with centralized control stations. The door controller 202 executes commands received from security personnel, logs access events, and transmits system diagnostics for maintenance and auditing purposes.

The control center 302 is a centralized command hub configured to manage and oversee the operation of the smart frame 100 within a secured facility. The control center 302 receives status updates from the smart frame processor 304, enabling real-time monitoring and response to security events. The control center 302 includes operator workstations, electronic displays, and communication terminals that facilitate remote access management and door status tracking.

The door controller 202 receives authentication data, monitors door status, and actuates the door lock 108 based on control signals received from the smart frame processor 304. The door controller 202 processes data from the plurality of sensors 204, including the door position sensor 106 and tamper detection sensors, ensuring real-time security monitoring.

The smart frame 100 is communicable with the door controller 202 and integrates multiple access control and monitoring components. The modular assembly 110 houses electronic modules that facilitate secure entry authentication and door status indication. The door lock 108 is configured for electronic actuation, via the door lock assembly 112, allowing the door controller 202 to engage or release the locking mechanism in response to validated access credentials.

The network cable 306 provides both power and data transmission between the smart frame processor 304, the modular assembly 110, the door controller 202, and the plurality of modular systems 208, eliminating the need for separate wiring for power and communication. The network cable 306 enables high-speed data exchange, supporting real-time security event logging and access control verification.

The detention center security network 300 allows for centralized control and monitoring of multiple smart frames 100, providing facility operators with an efficient and secure method of managing entry points within a detention facility. The integration of the control center 302, the smart frame processor 304, the door controller 202, and the modular assembly 110 to operate the smart frame 100 ensures precise control over door locking mechanisms, status monitoring, and access authorization.

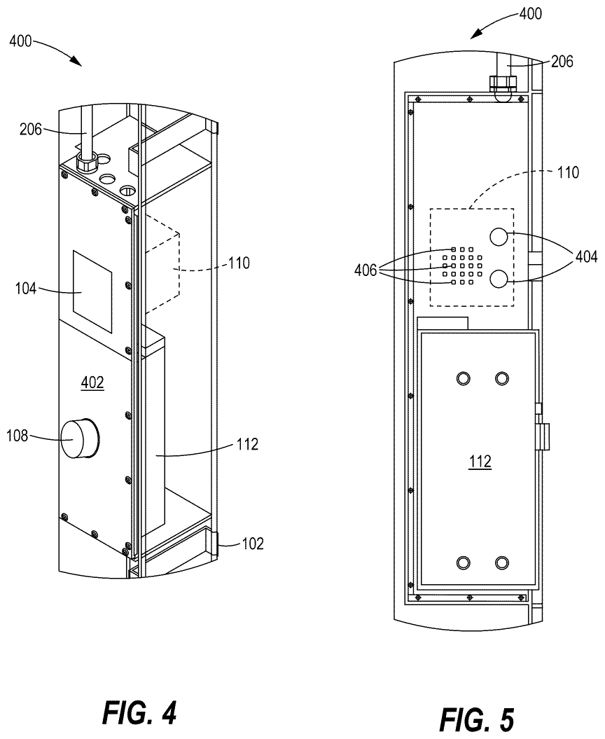

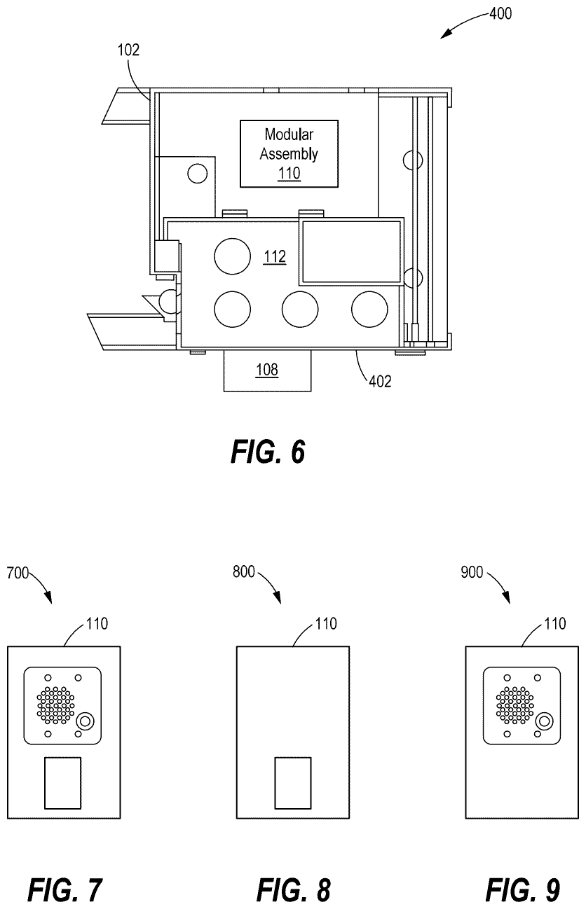

Referring now to FIGS. 4-6, FIG. 4 illustrates an isometric view of a smart box 400 integrated in the door frame 102, according to an embodiment of the disclosure. FIG. 5 illustrates a cross-sectional back view of the modular assembly 110 installed within a door frame 102, according to an embodiment of the disclosure. FIG. 6 illustrates a cross-sectional top view of the modular assembly 110 in the door frame 102, according to an embodiment of the disclosure.

Referring now to FIG. 4, the smart box 400 is illustrated integrated within the door frame 102 and is configured to house multiple security and communication components. The smart box 400 includes a cover plate 402, a set of pushbutton holes 404, and a set of speaker holes 406 integrated in the door frame 102. The smart box 400 serves as a protective enclosure for the electrical and access control components required for door operation. The cover plate 402 is secured to the smart box 400 and provides a finished surface for interfacing with security personnel or authorized users.

Referring now to FIG. 5, the smart box 400 is shown in a cross-sectional back view, illustrating its installation within the door frame 102. The smart box 400 is positioned within an internal cavity of the door frame 102, providing a secure enclosure for electrical components while minimizing exposure to tampering or environmental damage. The cover plate 402 is affixed to the front-facing portion of the smart box 400, allowing controlled access to the integrated controls. As shown in FIG. 5, the pushbutton holes 404 are positioned on the cover plate 402 and are configured to accommodate access control buttons, request-to-exit buttons, or other manual input devices. The pushbutton holes 404 allow users to interact with the smart box 400 by activating door release functions or triggering communication with security personnel. The speaker holes 406 are positioned adjacent to the pushbutton holes 404 and provide an acoustic pathway for an integrated speaker or intercom system. The speaker holes 406 facilitate audio communication between individuals inside and outside the secured area.

The pushbutton holes 404 extend through the cover plate 402, ensuring access to installed pushbutton components. The speaker holes 406 are aligned with an internal speaker unit, facilitating clear sound transmission for communication. The smart box 400 is secured within the door frame 102 using fastening elements or mounting brackets to prevent unauthorized removal or physical manipulation.

The smart box 400 is positioned in a manner that allows integration with other electronic access control components, including status indicators, biometric readers, or proximity sensors. The smart box 400 includes internal wiring pathways that facilitate connections to power and data lines, ensuring efficient communication between the smart frame processor 304 and the door controller 202 and modular assembly 110.

Referring now to FIG. 6, the cross-sectional top view of the smart box 400 illustrates the spatial arrangement of the modular assembly 110 within the door frame 102. The smart box 400 is structured to fit securely within the door frame 102, maintaining alignment with the internal access control components and accessible for receiving the network cable 306.

The cover plate 402 extends across a front face of the smart box 400, and may be further configured for providing the interface 104 externally for user interaction. The pushbutton holes 404 may also be evenly spaced on the cover plate 402, ensuring accessibility for users. The speaker holes 406 are positioned to allow unobstructed sound transmission from the integrated speaker unit. The internal structure of the modular assembly 110 is designed to accommodate multiple modular components, allowing for customization based on security requirements.

The smart box 400 provides a durable, integrated solution for housing access control and communication elements within the door frame 102. The arrangement of the modular assembly 110, the pushbutton holes 404, speaker holes 406, and internal wiring pathways ensures reliable operation while maintaining a streamlined and secure installation.

Referring now to FIGS. 7-9, FIG. 7 illustrates a first modular assembly 700, according to an embodiment of the disclosure. FIG. 8 illustrates a second modular assembly 800, according to an embodiment of the disclosure. FIG. 9 illustrates a third modular assembly 900, according to an embodiment of the disclosure.

Referring now to FIG. 7, the first modular assembly 700 includes a first set of the plurality of modular systems 208 housed within the modular assembly 110 and provides essential access control and communication functions. The first modular assembly 700 may be configured to include an authentication interface, a status indicator, and a manual release mechanism. The authentication interface is configured to receive user credentials through a keypad, RFID reader, biometric scanner, or other secure authentication methods. The status indicator provides a visual display of door access states, signaling whether the door lock 108 is engaged or disengaged. The manual release mechanism allows authorized personnel to override electronic locking functions in the event of an emergency or power failure.

The first modular assembly 700 is installed within the smart box 400 and is connected to the door controller 202 through internal wiring. The authentication interface transmits credential data to the door controller 202, which then verifies access permissions before engaging or releasing the door lock 108. The status indicator changes color or illuminates based on the access status, providing clear visual feedback for personnel monitoring the entry point. The manual release mechanism is physically protected by a security cover to prevent unauthorized use while allowing emergency access when necessary.

Referring now to FIG. 8, the second modular assembly 800 is a second set of the plurality of modular systems 208 housed within the modular assembly 110 for providing enhanced communication and monitoring functionality. The second modular assembly 800 includes an intercom unit, a call request button, and a remote access activation interface. The intercom unit is configured to facilitate audio communication between security personnel and individuals requesting access. The call request button enables users to send a request signal to the control center 302 for access authorization or emergency assistance. The remote access activation interface allows security personnel to release the door lock 108 remotely once access has been granted.

The second modular assembly 800 is positioned within the smart box 400 and is operably connected to the smart frame processor 304. The intercom unit includes a speaker and microphone system that ensures clear two-way communication. The call request button is designed with tactile feedback, allowing users to confirm that a request has been initiated. The remote access activation interface receives signals from the control center 302, which then instructs the door controller 202 to operate the door lock 108 accordingly.

Referring now to FIG. 9, the third modular assembly 900 includes a third set of the plurality of modular systems 208 housed in the modular assembly 110 and is configured for advanced security monitoring and system diagnostics. The third modular assembly 900 includes a tamper detection sensor, a security alarm interface, and an event logging module. The tamper detection sensor monitors unauthorized attempts to access or manipulate the smart box 400. The security alarm interface is configured to trigger audible or silent alarms in response to unauthorized entry attempts. The event logging module records access events, authentication attempts, and security alerts for audit and review purposes.

The third modular assembly 900 is integrated within the smart box 400 and is communicable with the door controller 202 and the control center 302. The tamper detection sensor activates when unauthorized force or tampering is detected, sending an alert to security personnel. The security alarm interface can be programmed to initiate lockdown procedures or notify security staff through automated alerts. The event logging module stores historical data, allowing security administrators to review access patterns and detect potential security threats.

The first modular assembly 700, second smart box module 800, and third modular assembly 900 are modular variations of the modular assembly 110 designed to include the plurality of modular systems 208 which fit within the modular assembly 110 and housed within the smart box 400. Each modular system 208 provides specific functionality tailored to access control, communication, and security monitoring. The modular design allows customization based on facility requirements, ensuring that the modular assembly 110 can be adapted for various security environments and scalable for multi-layered facilities and detention centers.

The smart frame 100 is configured to accommodate the plurality of modular systems 208, which may be provided with a variety of different modular systems. Varying options and configurations of the plurality of modular systems 208 provided in the modular assembly 110 integrate seamlessly with the door controller 202, enabling real-time data exchange and operational commands between the smart frame processor 304, the plurality of modular systems 208, and individual door entry points. The modular nature of the smart frame 100 and the module assembly 110, with varying options, allows facility operators to customize security and automation features based on operational needs while ensuring standardized communication over the network cable 206.

An access control system (ACS) within the smart frame 100 supports multiple authentication devices, including a card reader (HID) and a keypad reader (HID). These devices allow authorized personnel to gain entry using RFID credentials or secure passcodes. An audio system (AUD) incorporates an intercom with call button (Audiotec) for voice communication between individuals at the door and remote security personnel. An intercom with call button and audio program bus (Audiotec) further enhances the communication subsystem by supporting programmable voice announcements, automated access prompts, and integrated alarm notifications.

A duress and real-time tracking system (DUR) enhance security monitoring by integrating real-time location positioning (Actall) and duress system (Actall) modules. These devices provide personnel tracking capabilities and duress alerts, ensuring rapid response to emergency events. The programmable logic controller (PLC) manages critical operational functions such as door lock control and monitoring with tamper detection, key switch electronic access, and local door status indication LED. Additional PLC-controlled features include light dimming and light temperature adjustment buttons, allowing personnel to regulate conditions within controlled spaces.

The smart frame 100 is also equipped with dome light indication, a request to exit button, a request to exit motion sensor, and a temperature sensor. These elements provide visual, physical, and automated access exit functions, ensuring smooth facility operations while maintaining high-security standards. The options of the plurality of modular systems 208 provided in the smart frame 100 collectively enhance the overall detention center security network 1000, enabling modular configuration, centralized control, and seamless interoperability between access control, audio communication, duress response, and environmental management systems.

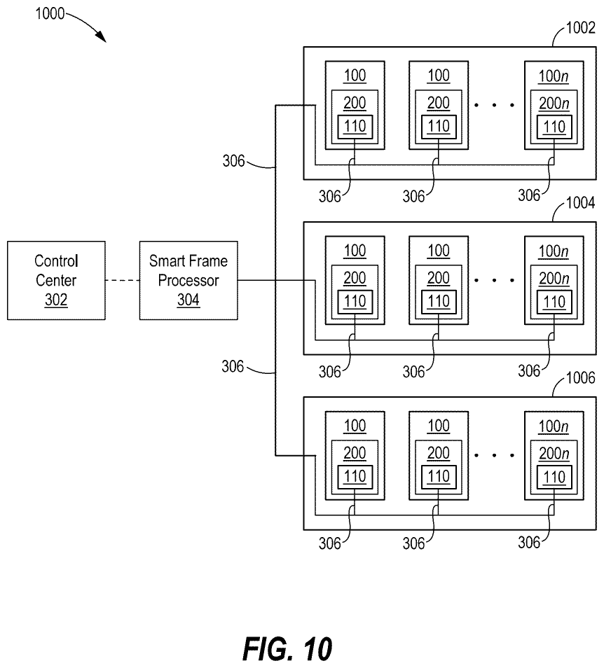

Referring now to FIG. 10, FIG. 10 illustrates a multi-layered detention center security network 1000, according to an embodiment of the disclosure. The multi-layered detention center security network 1000 includes a control center 302, a smart frame processor 304, a plurality of first doors 1002, a plurality of second doors 1004, a plurality of third doors 1006, and a plurality of the door controller 202 communicable with each corresponding smart frames 100 within the plurality of first doors 1002, the plurality of second doors 1004, and the plurality of third doors 1006.

The control center 302 is configured to manage the security and access operations of multiple entry points within a detention facility. The control center 302 receives status updates, access logs, and security alerts from each smart frame processor 304, ensuring real-time monitoring of facility access points and from each of the plurality of first doors 1002, the plurality of second doors 1004, and the plurality of third doors 1006. Security personnel at the control center 302 issue access commands, initiate lockdown procedures, and review event logs for security audits.

The smart frame processor 304 is operably connected to the control center 302 and is responsible for relaying commands and status updates between the control center 302 and the plurality of first doors 1002, plurality of second doors 1004, and plurality of third doors 1006. The smart frame processor 304 processes access requests, transmits lock engagement signals, and monitors security events for each smart frame 100.

The plurality of first doors 1002 are positioned within primary secured areas and are each controlled by a corresponding door controller 202. Each door controller 202 receives authentication data, monitors door status through the plurality of sensors 204, and engages or releases the door lock 108 based on validated access credentials. The plurality of first doors 1002 function as the first level of access restriction within the detention facility.

The plurality of second doors 1004 are positioned beyond the plurality of first doors 1002, such as in a second hallway or second floor building, and provide access to secondary secured areas. Each door controller 202 linked to the plurality of second doors 1004 is configured to enforce additional security layers, including biometric authentication, dual-factor access validation, or remote authorization from the control center 302. The plurality of second doors 1004 separate different security zones, ensuring restricted movement between facility sections.

The plurality of third doors 1006 are positioned within the innermost secured areas of the detention facility and are controlled through a networked connection with the smart frame processor 304. The plurality of third doors 1006 are configured for heightened security and may include additional reinforcements, such as advanced tamper detection mechanisms or manual override systems. The plurality of third doors 1006 restrict access to the most secure zones of the facility, ensuring controlled movement within highly restricted areas.

Each door controller 202 is connected to the smart frame processor 304 via the network cable 306, providing a structured communication link between access points and the control center 302. The network cable 306 transmits both power and data, eliminating the need for separate electrical wiring and ensuring reliable real-time communication. Each door in the plurality of first doors 1002, the plurality of second doors 1004, and the plurality of third doors 1006 includes the smart frame 100 having the same or varying features of the module assembly 110 and/or other components.

The multi-layered detention center security network 1000 integrates the control center 302, the smart frame processor 304, the plurality of first doors 1002, the plurality of second doors 1004, and the plurality of third doors 1006 to maintain a highly secure access environment. The modular nature of the door controllers 202 and smart frames 100 allows for scalable expansion, enabling security personnel to manage facility-wide access with precision and efficiency.

The multi-layered detention center security network 1000 is designed to support various configurations of the smart frame 100 with a variety of configurations of the plurality of modular systems 208, allowing different sections of a facility to operate with tailored security, communication, and automation features while remaining connected over a single network cable 306. The smart frame processor 304 dynamically manages multiple door controllers 202, each configured with distinct variations of the modular assembly 110 based on the security level and operational requirements of specific areas within the facility. The network cable 306 may connect to the modular assembly 110 above or below an aperature (not shown) provided in the door frame 102.

In high-security zones, smart frames 100 may integrate duress system (Actall) and real-time location positioning (Actall) to track personnel movement and generate alerts during emergencies. Meanwhile, in administrative or general access areas, card readers (HID) and keypad readers (HID) provide streamlined access control without requiring additional security layers.

The use of a unified Ethernet cable network, as the network cable 306, for power and data transmission eliminates the need for separate wiring infrastructures for different subsystems, enabling centralized control with minimal installation complexity. The smart frames 100 in detention cells, perimeter checkpoints, and staff-only areas can each incorporate programmable logic controller (PLC) functions such as door lock monitoring, local status indication LEDs, and request-to-exit motion sensors, all seamlessly managed through the door controllers 202. The audio system (AUD) modules, including intercoms with call buttons (Audiotec), allow facility-wide communication, ensuring that security personnel can respond to access requests and emergencies in real time.

By enabling flexible module configurations under a unified multi-layered detention center security network 1000, facilities can maintain a scalable and adaptive security infrastructure that meets varying operational demands while maintaining a streamlined, reliable communication backbone.

To accommodate varying installation environments, the smart frame 100 may be provided in a variety of structural configurations and materials. The frame may be constructed from stainless steel, aluminum alloy, or reinforced composite materials, selected based on environmental exposure, fire-rating requirements, or anti-ligature standards. Alternate body types may include configurations with extended vertical supports for high-ceiling installations, recessed profiles for flush wall integration, or frames with integrated hinges for swing-type doors. Surface treatments such as powder coating or anodizing may be applied for corrosion resistance and aesthetic alignment with facility standards.

The smart frame 100 may be manufactured in standardized widths and heights to match common door sizes, with adjustable panel inserts to accommodate non-standard openings. Modular expansion panels may be affixed to either side of the frame to house additional components such as secondary access interfaces, environmental control devices, or supplemental power systems. Each expansion panel is prewired to integrate seamlessly with the modular assembly 110 and network cable 306, allowing for plug-and-play scalability.

To ensure uninterrupted functionality during power outages, the smart frame 100 may include a backup power module housed within the smart box 400, within the modular assembly 110, or adjacent to the smart box 400. This module may comprise a lithium-ion battery pack or supercapacitor system capable of sustaining sensor monitoring, lock actuation, and basic communication functions for a predefined period (e.g., 30-90 minutes). An automatic power transfer switch may detect loss of main power and initiate the backup sequence without user intervention.

For enhanced security, all access panels and mounting elements of the smart frame 100 may be configured with tamper-resistant fasteners and shielded cable paths. Internal channels may be used to conceal wiring, while the access control components may be further shielded by reinforced lockable covers requiring specialized tools to open. Sensors embedded in the smart box 400 and/or modular assembly 110 may detect unauthorized panel removal and trigger alerts through the detention center security network 300.

The integration between the door frame 102 and the modular assembly 110 establishes a structurally and functionally unified smart frame 100 that enables seamless operation and connectivity. This unique configuration marries the physical frame components with embedded access control and monitoring systems, resulting in a cohesive assembly that simplifies installation, enhances security, and reduces service complexity. An internal conduit path may be formed within the door frame 102 enabling direct routing of power and communication lines from the network cable 306 to the smart box 400 within the door frame 102 and to the modular assembly 110. The internal conduit path of the network cable 306 may enter the door frame 102 through the top, bottom, or side of the door frame 102, depending on field conditions or facility center arrangements. The modular assembly 110 is configured to communicate over the network cable 306, enabling the door controller 202 to operate all critical components of the smart frame 100.

The smart frame 100 and modular assembly 110 are collectively structured to support both standardized and configurable functionality, allowing the same platform to be adapted across a range of secure environments. The consolidated design streamlines connectivity to the smart frame processor 304, allowing for real-time management and remote diagnostics through a single power and data interface. This ensures that deployment within various institutional settings can be achieved with minimal disruption and maximum scalability.

Facilities such as correctional institutions and mental health centers often require tailored access control solutions. The smart frame 100 is designed to support distinct operational requirements in these environments through customization of the modular assembly 110. For example, correctional facilities may demand tamper-proof sensors 204, and programmable lockdown protocols integrated via the door controller 202 and modular systems 208. Mental health facilities may require safety-oriented features such as anti-ligature door hardware, visual status indicators with calming color palettes or lightings, and delayed egress functionality to reduce patient distress. The smart frame 100, through its interchangeable modules and software-configurable logic via the programmable logic controller (PLC), accommodates these differing needs without requiring fundamental architectural changes to the frame structure.

In an embodiment, the smart box 400 and modular assembly 110 are further configured to integrate artificial intelligence (AI) and machine learning (ML) functionalities to enhance operational adaptability, predictive diagnostics, and real-time threat detection within the detention center security network 300. A trained AI model, hosted on the smart frame processor 304 or on a secure cloud server communicable via the network cable 306, may analyze sensor data collected by the plurality of sensors 204 to identify patterns indicative of tampering attempts, unauthorized access behaviors, or equipment degradation. The door controller 202 may dynamically adjust operation of the plurality of modular systems 208, including authentication interface, tamper detection sensor, or access status indicators, based on AI-driven analysis to improve responsiveness and reduce false positives in high-security environments.

### INDUSTRIAL APPLICABILITY

In operation, the present disclosure finds industrial applicability in the design, installation, and operation of secure access control systems within institutional environments, including detention centers, correctional facilities, government buildings, and other high-security infrastructures. The smart frame system 200 described herein offers integrated electronic monitoring, controlled entry, and modular configurability in support of secure movement and safety management.

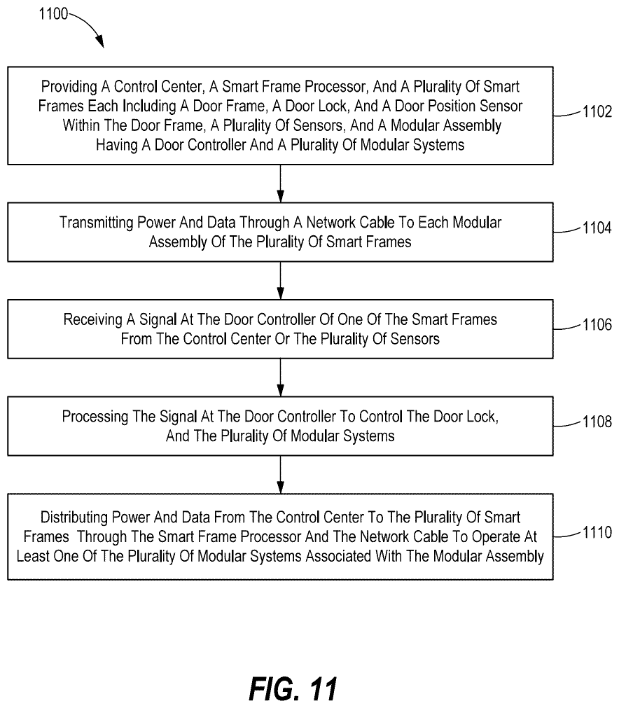

Referring now to FIG. 11, a method 1100 of operating a detention facility is illustrated. The method 1100 begins in a step 1102 with providing the control center 302, the smart frame processor 304, and a plurality of smart frames 100, each smart frame 100 including the door frame 102, the door lock assembly 112, the modular assembly 110 with the door controller 202, and the door position sensor 106 within the door frame 102. The smart frame system 200 is configured such that these smart frames may be deployed throughout a detention facility in varying security zones.

In a step 1104, power and data are transmitted through the network cable 306 to each modular assembly 110 of the plurality of smart frames 100. In a step 1106, a signal is received at the door controller 202 of one of the smart frames 100, which may correspond to a command from the control center 302 or a user-initiated request at the interface 114 of the smart frame 100. In a step 1108, the signal is processed at the door controller 202 to control the door lock assembly 112, enabling automated or authorized manual actuation. In a step 1110, power and data are distributed from the control center 302 to the smart frames 100 through the smart frame processor 304 and the network cable 306 to operate at least one of a plurality of modular systems 208 associated with the modular assembly 110.

The system facilitates real-time monitoring and control across a detention facility, enabling centralized coordination of secure entry and exit points. The modularity of each smart frame 100 allows for customization based on zone-specific requirements, such as tamper detection, delayed egress, intercom communication, authentication, and visual signaling. Operational scalability is supported through standardized network infrastructure, minimizing the complexity and labor traditionally associated with security system installation and maintenance.

The disclosed smart frame 100, smart frame system 200, and the modular assembly 110 may each be retrofitted into existing detention facilities to upgrade legacy door systems without requiring full structural replacement. By utilizing standardized mounting configurations and network cable pathways, the modular components can be integrated into pre-existing door frames or security enclosures. The retrofit process supports reuse of existing infrastructure while enabling advanced functionality such as networked access control, real-time monitoring, and modular system customization. This retrofit capability reduces downtime, lowers installation costs, and ensures compatibility with modern centralized control systems, making the technology highly suitable for phased upgrades across aging institutional environments.

From the foregoing, the disclosed system and method offer industrial applicability in environments requiring centralized security, scalable access control, and modular hardware configurations, particularly within correctional, mental health, and high-security government institutions.

What is claimed is:

1. A smart frame comprising:
a door frame;
a door lock disposed in the door frame;
a modular assembly disposed in the door frame, the modular assembly including a door controller operable to control the door lock and a plurality of modular systems;
a door position sensor disposed in the door frame and communicable with the door controller; and
a network cable configured to transmit power and data to the modular assembly for operating the plurality of modular systems.

2. The smart frame of claim 1, wherein the plurality of modular systems includes at least one modular system selected from the group consisting of an authentication interface, a status indicator, an intercom communication module, a tamper detection sensor, an electronic locking mechanism, a visual status indicator, and a manual release mechanism.

3. The smart frame of claim 1, further comprising an interface disposed on the door frame and operable to communicate with the modular assembly.

4. The smart frame of claim 1, further comprising a control center in communication with a smart frame processor, the smart frame processor in further communication with the door controller of the smart frame.

5. The smart frame of claim 4, wherein the smart frame processor is communicable with a plurality of door controllers, each door controller within a plurality of smart frames each having one of the modular systems for transmitting operational commands and receiving status updates from the plurality of modular systems.

6. The smart frame of claim 1, further comprising a plurality of the door frames deployed within a multi-layered detention center security network including a plurality of first doors, a plurality of second doors, and a plurality of third door.

7. The smart frame of claim 6, further comprising a plurality of modular systems disposed in the modular assembly of each of the plurality of door frames, such that the first doors, second doors, and third doors each have different modular systems.

8. The smart frame of claim 1, further comprising a cover plate affixed to the door frame and configured to be removable to allow access to or replacement of the modular assembly.

9. A detention center security system comprising:
at least one smart frame including:
a door frame;
a door lock disposed in the door frame;
a modular assembly disposed in the door frame, the modular assembly having a door controller operable to control the door lock and a plurality of modular systems; and
a door position sensor disposed in the door frame and communicable with the door controller;
a smart frame processor in communication with the door controller via a network cable, the network cable configured to transmit power and data to the modular assembly for operating the plurality of modular systems; and
a control center for transmitting operational commands and receiving status updates of the at least one smart frame, the control center in communication with the smart frame processor and the door controller of the at least one smart frame.

10. The detention center security system of claim 9, wherein the plurality of modular systems include at least one modular system selected from the group consisting of an authentication interface, a status indicator, an intercom communication module, a tamper detection sensor, an electronic locking mechanism, a visual status indicator, and a manual release mechanism.

11. The detention center security system of claim 9, further comprising an interface disposed on the door frame and operable to communicate with the modular assembly.

12. The detention center security system of claim 10, wherein the door controller is in communication with the door position sensor and the plurality of modular systems by at least one chosen from the group consisting of a cable, a wifi network, and a Bluetooth network.

13. The detention center security system of claim 10, wherein the authentication interface is configured to receive credentials through one chosen from the group consisting of a keypad, an RFID reader, and a biometric scanner.

14. The detention center security system of claim 9, further comprising a plurality of first doors, a plurality of second doors, and a plurality of third doors, the plurality of first doors, the plurality of second doors, and the plurality of third doors each having the at least one smart frame.

15. The detention center security system of claim 14, wherein the modular assembly may be chosen from the group consisting of a first modular assembly, a second modular assembly and a third modular assembly, and each of the plurality of first doors, the plurality of second doors, and the plurality of third doors include the first modular assembly, the second modular assembly or the third modular assembly.

16. The detention center security system of claim 15, wherein the first modular assembly includes a first plurality of modular systems, the second modular assembly includes a second plurality of modular systems, and the third modular assembly includes a third plurality of modular systems, and wherein the network cable is configured to transmit power and data to each of the first modular assembly, the second modular assembly and the third modular assembly in the plurality of first doors, the plurality of second doors, and the plurality of third door.

17. A method of operating a detention facility, comprising
providing a control center, a smart frame processor, and a plurality of smart frames each including a door frame, a door lock, a door position sensor within the door frame, a modular assembly having a door controller and a plurality of modular systems, and a plurality of sensors in communication with the door controller;
transmitting power and data through a network cable to each modular assembly of the plurality of smart frames;
receiving a signal at the door controller of one of the smart frames;
processing the signal at the door controller to control the door lock, the plurality of sensors, or the plurality of modular systems; and
distributing power and data from the control center to the plurality of smart frames through the smart frame processor and the network cable to operate at least one of the plurality of modular systems associated with the modular assembly.

18. The method of claim 17, further comprising monitoring the door position sensor to determine an open or closed status of a door in the detention facility.

19. The method of claim 17, further comprising organizing the plurality of smart frames across a multi-layered detention center security network including first doors, second doors, and third doors positioned in separate secured zones of the facility.

20. The method of claim 19, further comprising providing a plurality of modular systems in the modular assembly of each of the plurality of smart frames, such that the first doors, second doors, and third doors each include different modular systems based on the security level of each zone, the plurality of modular systems including at least one modular system selected from the group consisting of an authentication interface, a status indicator, an intercom communication module, a tamper detection sensor, an electronic locking mechanism, a visual status indicator, and a manual release mechanism.
